(19) United States
(12) Patent Application Publication
(10) Pub. No.: US 2024/0010889 A1
(43) Pub. Date: Jan. 11, 2024

(54) ONE-COMPONENT THERMOSETTING EPOXY ADHESIVE WITH IMPROVED ADHESION AT HIGH TEMPERATURES

(71) Applicant: SIKA TECHNOLOGY AG, Baar (CH)

(72) Inventors: Kiki WEI, Suzhou (CN); Weiming ZHANG, Suzhou (CN); Elyes JENDOUBI, Suzhou (CN); Jessica LIN, Suzhou (CN)

(73) Assignee: SIKA TECHNOLOGY AG, Baar (CH)

(21) Appl. No.: 18/035,672

(22) PCT Filed: Dec. 24, 2020
(86) PCT No.: PCT/CN2020/138923

§ 371 Date: May 5, 2023

(51) Int. Cl. C09J 163/04; C08G 59/24; C08G 59/32; C08G 59/40

(52) U.S. Cl. CPC C09J 163/04; C08G 59/245; C08G 59/3227; C08G 59/4021; C09J 2463/00; C09J 2301/304; C09J 2400/163

(57) ABSTRACT

A one-component thermosetting epoxy resin adhesive, includes: a) at least one epoxy resin A of the formula (II):

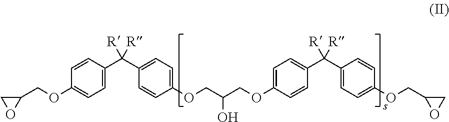

wherein the substituents R′ and R″ independently of one another are either H or CH₃ and the index s has a value of 0-12, at least one epoxy novolac EN of the formula:

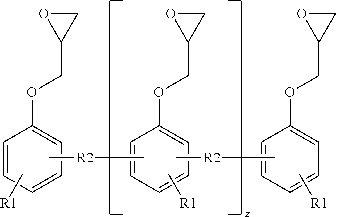

where R2=

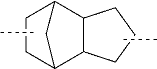

or CH₂, R1=H or methyl and z=0-7, at least one trifunctional or higher functional glycidyl amine type epoxy resin GA, least one latent hardener B for epoxy resins and at least at least one toughness improver D. The epoxy resin adhesive is notable in particular for providing a one-component thermosetting epoxy resin adhesive which shows good adhesion on metal substrates at temperatures around 80° C., even when cured at relatively low temperatures.

### TECHNICAL FIELD

The present invention pertains to the field of one-component thermosetting epoxy resin adhesives and also to the use thereof particularly in vehicle construction.

### PRIOR ART

Thermosetting, one-component epoxy resin adhesives have already been used for some considerable time as adhesives in body construction.

One important field of use of one-component thermosetting epoxy resin adhesives, accordingly, is in vehicle construction, where typically there are metal substrates such as steel sheets and aluminium present, particularly in the context of adhesive bonding. Following the application of the epoxy resin composition, the bodywork is heated in the CEC (cathodic electrocoating) oven, by means of which the thermosetting epoxy resin composition as well is cured.

WO 2013142750 A2 describes heat curable structural adhesives in vehicle construction. In the experimental part, adhesives are disclosed that contain 0.6 to 0.7 wt.-% of an activatable catalyst consisting of a mixture of a tertiary amine and a novolac resin.

Such structural adhesives have to fulfil a variety of requirements including good adhesion on metal substrates such as steel sheets, especially oiled steel sheets, and aluminium, and good mechanical properties. These requirements are particularly difficult to meet when a low curing temperature, especially a temperature below 170° C., was used to cure the adhesive and the cured adhesive is exposed to temperatures around 80° C. for extended periods of time. Such temperatures often occur in proximity of the engine of heavy-duty vehicles like asphalt pavers, loaders, compactors and dozers.

However, efforts are currently under way in the market to lower the temperature of the cathodic electrocoating ovens. Thus, there is a great need in the market for one-component epoxy resin adhesives that provides good adhesion, especially lap shear strength, on metal substrates at temperatures around 80° C., even when cured at relatively low temperatures, i.e. at a temperature of 160 to 170° C., and even after a short curing time, typically 10 to 15 minutes.

### SUMMARY OF THE INVENTION

It is an object of the present invention, therefore, to provide a one-component thermosetting epoxy resin adhesive which shows good adhesion on metal substrates at temperatures around 80° C., especially lap shear strength, even when cured at relatively low temperatures, i.e. at a temperature of 160 to 170° C., even after a short curing time, typically 10 to 15 minutes.

Surprisingly it has been found that this object can be achieved with the one-component thermosetting epoxy resin adhesive as defined in Claim 1.

Further aspects of the invention are subjects of further independent claims. Particularly preferred embodiments of the invention are subjects of the dependent claims.

### CERTAIN EMBODIMENTS OF THE INVENTION

The present invention therefore relates to a one-component thermosetting epoxy resin adhesive, comprising
a) at least one epoxy resin A of the formula (II)

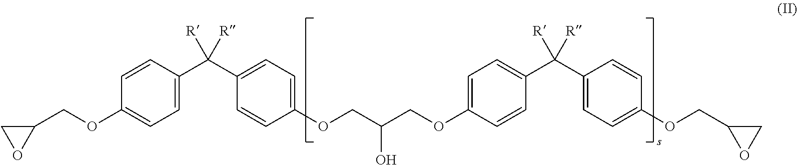

wherein the substituents R′ and R″ independently of one another are either H or CH₃ and the index s has a value of 0-12, preferably 0-1; and
b) at least one epoxy novolac EN of the formula

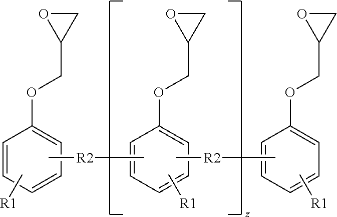

where R2=

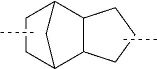

or CH₂, R1=H or methyl and z=0-7, preferably 0-3, 1-2, most preferably 1.2-2; and
c) at least one trifunctional or higher functional glycidyl amine type epoxy resin GA
d) at least one latent hardener B for epoxy resins; and
e) preferably at least one accelerator C for epoxy resins; and
f) at least at least one toughness improver D.

The epoxy resin adhesive is one-component, meaning that the constituents of the epoxy resin adhesive, more particularly the epoxy resin and the hardener, are present in one component, without curing taking place at usual ambient temperature or room temperature. The one-component epoxy resin adhesive is therefore storage-stable. It can therefore be handled in this form, whereas with two-component systems the components cannot be mixed until immediately prior to use.

The curing of the one-component epoxy resin adhesive is accomplished by heating, typically at a temperature of more than 70° C., preferably in the range from 100 to 220° C., for example.

The prefix “poly” in expressions such as polyol or polyisocyanate denotes that the compound has two or more of the stated groups. A polyisocyanate, for example, is a compound having two or more isocyanate groups.

The expression “independently of one another” as used below means that in the same molecule, two or more identically denoted substituents may have identical or different meanings in accordance with the definition.

The dashed lines in the formulae in this document represent in each case the bond between the substituent in question and the associated remainder of the molecule.

Room temperature refers here to a temperature of 23° C., unless otherwise indicated.

The thermosetting one-component epoxy resin adhesive comprises at least one epoxy resin A of the formula (II)

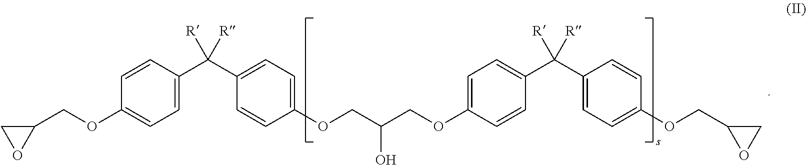

The substituents R′ and R″ independently of one another are either H or CH₃, preferably CH₃, and the index s has a value of 0-12, preferably 0-1, more preferably 0-0.2.

Preferably, in the epoxy resin A the substituents R′ and R″ are CH₃ and the index s has a value of 0-1, preferably 0-0.2.

The resins in question are therefore preferably diglycidyl ethers of bisphenol A (DGEBA), of bisphenol F and also of bisphenol A/F. Liquid resins of these kinds are available for example as Araldite® GY 250, Araldite® PY 304, Araldite® GY 282 (Huntsman) or D.E.R.™ 331 or D.E.R.™ 330 (Dow) or Epikote 828 (Hexion).

The thermosetting one-component epoxy resin adhesive further comprises at least one epoxy novolac EN of the formula

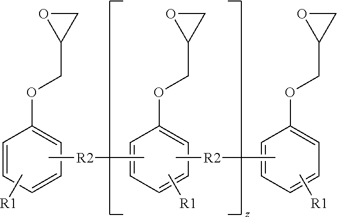

where R2=

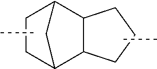

or CH₂, R1=H or methyl and z=0-7, preferably 0-3, 1-2, most preferably 1.2-2.

Preferably, in the epoxy novolac EN R2=CH₂ and R1=H and z=1-2. Suitable epoxy novolac EN are marketed under the commercial designations D.E.N. 439 (EEW 191 to 210 g/eq, functionality 3.8), D.E.N. 438 (EEW 176 to 181 g/eq, functionality 3.6), Araldite® EPN 1183 (EEW 145 to 159 g/eq, functionality 3.3) and D.E.N. 431 (EEW 172 to 179 g/eq, functionality 2.8). Araldite® EPN 1183 being especially preferred.

If the one-component thermosetting epoxy resin adhesive does not contain the at least one epoxy novolac EN, the lap shear strength at 80° C. at low bake conditions is not sufficient. This can be seen for example in the comparison of Ref. 1 and Ref. 2 with Ex. 1-Ex. 4 in table 1.

The thermosetting one-component epoxy resin adhesive further comprises at least one trifunctional or higher functional glycidyl amine type epoxy resin GA, more preferably a tetrafunctional or higher functional glycidyl amine type epoxy resin, most preferably a tetrafunctional glycidyl amine type epoxy resin.

The trifunctional or higher functional glycidyl amine type epoxy resin GA is preferably selected from the list consisting of triglycidyl aminophenol epoxy compounds, triglycidyl aminocresol epoxy compounds, tetraglycidyl diaminodiphenyl methane epoxy compounds, tetraglycidyl meta-xylylenediamine epoxy compounds, tetraglycidyl bisamino methyl cyclohexane epoxy compound and tetraglycidyl glycoluril epoxy compounds, more preferably selected from the list consisting of triglycidyl aminophenol epoxy compounds and tetraglycidyl diaminodiphenyl methane epoxy compounds, especially tetraglycidyl diaminodiphenyl methane epoxy compounds.

More preferably, the trifunctional or higher functional glycidyl amine type epoxy resin GA is preferably selected from the list consisting of

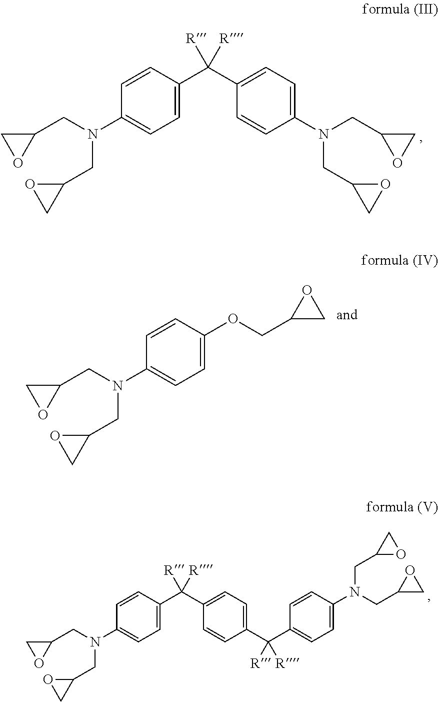

wherein the substituents R″′ and R″″ independently of one another are either H or CH₃, preferably H.

Most preferably, the trifunctional or higher functional glycidyl amine type epoxy resin GA is of formula (III).

Suitable trifunctional or higher functional glycidyl amine type epoxy resin GA are marketed under the commercial designations Araldite® MY 721, MY 722, MY 720, MY 9512 or MY 510 from Huntsman or Epon HPT 1072 from Shell.

If the one-component thermosetting epoxy resin adhesive does not contain the at least one trifunctional or higher functional glycidyl amine type epoxy resin GA, the lap shear strength at 80° C. at low bake conditions is not sufficient. This can be seen for example in table 1 in the comparison of Ref. 1, Ref. 3 and Ref. 4 with Ex. 1-Ex. 4.

Preferably, the molar ratio of the epoxy groups of the at least one epoxy novolac EN: the at least one trifunctional or higher functional glycidyl amine type epoxy resin GA (EN/GA) is 0.15-12, preferably 0.18-10, 0.18-8, 0.18-5, 0.18-3, 0.2-2, 0.5-1.5, more preferably 0.75-1.25.

The weight ratio of the at least one epoxy novolac EN:the at least one trifunctional or higher functional glycidyl amine type epoxy resin GA (EN/GA) is preferably 0.15-15, more preferably 0.2-12, 0.2-10, 0.2-7.5, 0.2-5, 0.2-2.5, 0.5-2, 0.5-1.5, most preferably 0.75-1.2.

The before mentioned ratios have the technical advantage of high values for the lap shear strength at 80° C. at low bake conditions. Further, the difference in the LSS values after curing for 10 min at 160° C. at 80° C., compared to the value measured at 23° C., are smaller and therefore the adhesives perform more similar at the different temperatures. This can be seen for example in table 1 in the comparison of Ex. 1 and Ex. 2 with Ex. 3 and Ex. 4

It can be further preferred if the molar ratio of the epoxy groups of the at least one epoxy novolac EN: the at least one trifunctional or higher functional glycidyl amine type epoxy resin GA (EN/GA) is 0.15-12, preferably 0.18-11, 0.5-11, 0.75-11, 1.5-11, 2-10, 5-10, 7.5-10, more preferably 8-9.

The weight ratio of the at least one epoxy novolac EN:the at least one trifunctional or higher functional glycidyl amine type epoxy resin GA (EN/GA) is preferably 0.15-15, more preferably 0.2-15, 0.5-15, 1-12, 2-12, 2.5-12, 5-12, 7.5-12, most preferably 9-11

These before mentioned ratios have the technical advantage of high values for the lap shear strength at 23° C. at low bake conditions, lap shear strength at 23° C. and 80° C. at normal bake conditions as well as T-peel. This can be seen for example in table 1 in the comparison of with Ex. 3 and Ex. 4 with Ex. 1 and Ex. 2.

It is further preferred, if the molar ratio of the epoxy groups of at least one epoxy resin A:the sum the at least one epoxy novolac EN and the at least one trifunctional or higher functional glycidyl amine type epoxy resin GA (A/(EN+GA)) is 0.2-2.5, preferably 0.3-2.1, 0.4-1.9, 0.5-1.9, 0.75-1.9, 1-1.9, 1.25-1.9, more preferably 1.5-1.8.

The weight ratio of at least one epoxy resin A:the sum the at least one epoxy novolac EN and the at least one trifunctional or higher functional glycidyl amine type epoxy resin GA (A/(EN+GA)) is preferably 0.35-4, more preferably 0.4-3, 0.5-2.5, 0.75-2.5, 1-2.5, 1.5-2.5, most preferably 1.8-2.2.

The before mentioned ratios have the technical advantage of high values for the lap shear strength at low and normal bake conditions and especially high values for T-peel. This can be seen for example in table 1 in the comparison of with Ex. 5 with Ex. 3.

It is further preferred, if the weight ratio of the at least at least one toughness improver D:the sum of the at least one epoxy resin A, the at least one epoxy novolac EN and the at least one trifunctional or higher functional glycidyl amine type epoxy resin GA (D/(A+EN+GA)) is 1-15, preferably 2-12, 3-11, 3.5-11, 4-11, 4.5-10, 4.5-8, 4.5-6, more preferably 5-5.5. This has the technical advantage of high values for the lap shear strength at low and normal bake conditions and high values for T-peel. Further, the difference in the LSS values after curing for 10 min at 160° C. at 80° C., compared to the value measured at 23° C., are smaller and therefore the adhesives perform more similar at the different temperatures. This can be seen for example in the comparison of with Ex. 6 and Ex. 7 with Ex. 3 in table 1.

The total fraction of the sum of the at least one epoxy resin A, the at least one epoxy novolac EN and the at least one trifunctional or higher functional glycidyl amine type epoxy resin GA is advantageously 30-70 weight-%, preferably 35-60 weight-%, 40-55 weight-%, most preferably 45-50 weight-%, based on the total weight of the epoxy resin adhesive.

The thermosetting one-component epoxy resin adhesive can further comprise at least one epoxy-bearing reactive diluent G. Such reactive diluents are known to those skilled in the art. Preferred examples of epoxy-bearing reactive diluents are:
glycidyl ethers of monofunctional saturated or unsaturated, branched or unbranched, cyclic or open-chain C₄-C₃₀ alcohols, e.g. butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether;
glycidyl ethers of difunctional saturated or unsaturated, branched or unbranched, cyclic or open-chain C₂-C₃₀ alcohols, for example ethylene glycol glycidyl ether, butanediol glycidyl ether, hexanediol glycidyl ether, octanediol glycidyl ether, cyclohexanedimethanol diglycidyl ether, neopentyl glycol diglycidyl ether;
glycidyl ethers of tri- or polyfunctional, saturated or unsaturated, branched or unbranched, cyclic or open-chain alcohols, such as epoxidized castor oil, epoxidized trimethylolpropane, epoxidized pentaerythritol or polyglycidyl ethers of aliphatic polyols such as sorbitol, glycerol or trimethylolpropane;
glycidyl ethers of phenol compounds and aniline compounds, such as phenyl glycidyl ether, cresyl glycidyl ether, p-tert-butylphenyl glycidyl ether, nonylphenol glycidyl ether, 3-n-pentadecenyl glycidyl ether (from cashewnutshell oil), N,N-diglycidylaniline;
epoxidized amines such as N,N-diglycidylcyclohexylamine;
epoxidized mono- or dicarboxylic acids, such as glycidyl neodecanoate, glycidyl methacrylate, glycidyl benzoate, diglycidyl phthalate, tetrahydrophthalate and hexahydrophthalate, diglycidyl esters of dimeric fatty acids;
epoxidized di- or trifunctional, low to high molecular weight polyether polyols, such as polyethylene glycol diglycidyl ether, polypropylene glycol diglycidyl ether.

Particular preference is given to hexanediol diglycidyl ether, cresyl glycidyl ether, p-tert-butylphenyl glycidyl ether, polypropylene glycol diglycidyl ether and polyethylene glycol diglycidyl ether.

Preferably, the fraction of the epoxy-bearing reactive diluent G is from 0-5 wt.-%, 0-2 wt.-%, 0-1 wt.-%, 0-0.5 wt.-%, 0-0.1 wt.-%, more preferably 0-0.01 wt.-%, based on the total weight of the one-component thermosetting epoxy resin adhesive.

The thermosetting one-component epoxy resin adhesive further comprises at least one latent hardener B for epoxy resins. Latent hardeners are substantially inert at room temperature and are activated by elevated temperature, typically at temperatures of 70° C. or more, thereby initiating the curing reaction. The customary latent hardeners for epoxy resins can be used. Preference is given to a latent epoxy resin hardener B containing nitrogen.

The latent hardener B is preferably selected from dicyandiamide, guanamines, guanidines, aminoguanidines and derivatives thereof, substituted ureas, imidazoles and amine complexes, preferably dicyandiamide.

The latent hardener B is preferably used in a stoichiometric amount based on the epoxy groups in the composition. The molar ratio of the epoxy groups to the active hydrogen of the latent hardener B is preferably 0.8 to 1.2, in particular 0.9 to 1.1, preferably 0.95 to 1.05.

The fraction of the latent hardener B is preferably 0.5 to 12 wt %, more preferably 1 to 8 wt %, more particularly 2-6 wt %, based on the total weight of the one-component thermosetting epoxy resin adhesive.

The thermosetting one-component epoxy resin adhesive further comprises at least one accelerator C for epoxy resins.

Such accelerating curing agents are preferably substituted ureas, for example 3-(3-chloro-4-methylphenyl)-1,1-dimethylurea (chlortoluron) or phenyldimethylureas, especially p-chlorophenyl-N,N-dimethylurea (monuron), 3-phenyl-1,1-dimethylurea (fenuron) or 3,4-dichlorophenyl-N,N-dimethylurea (diuron). In addition, it is possible to use compounds from the class of the imidazoles, such as 2-isopropylimidazole or 2-hydroxy-N-(2-(2-(2-hydroxy-phenyl)-4,5-dihydroimidazol-1-yl)ethyl)benzamide, imidazolines, trihalide complexes, preferably BF₃ complexes, blocked amines and encapsulated amines.

Preferably, the accelerator C for epoxy resins is selected from the list consisting of substituted ureas, imidazoles, imidazolines and blocked amines, preferably substituted ureas.

More preferably, the accelerator C for epoxy resins is selected from the list consisting of substituted ureas and blocked amines, especially when the latent hardener B is a guanidine, especially dicyandiamide.

Most preferably, the latent hardener B is a guanidine, especially dicyandiamide, and the one-component thermosetting epoxy resin composition additionally includes an accelerator C for epoxy resins, selected from the list consisting of substituted ureas and blocked amines, especially substituted ureas.

Preferably, the fraction of the accelerator C for epoxy resins is from 0.05-2 wt.-%, 0.1-1 wt.-%, 0.15-0.5 wt.-%, more preferably 0.2-0.3 wt.-%, based on the total weight of the one-component thermosetting epoxy resin adhesive.

The one-component thermosetting epoxy resin adhesive comprises at least one toughness improver D. The toughness improvers D may be solid or liquid.

The fraction of toughness improver D is from 2-30 wt.-%, preferably from 3-25 wt.-%, 4-20 wt.-%, 5-15 wt.-%, more preferably 5-10 wt.-%, based on the total weight of the one-component thermosetting epoxy resin adhesive.

More particularly the toughness improver D is selected from the group consisting of terminally blocked polyurethane polymers D1, liquid rubbers D2 and core-shell polymers D3. With preference the toughness improver D is selected from the group consisting of terminally blocked polyurethane polymers D1 and liquid rubbers D2, most preferably a terminally blocked polyurethane polymer D1.

Where the toughness improver D is a terminally blocked polyurethane polymer D1, it is preferably a terminally blocked polyurethane prepolymer of the formula (I).

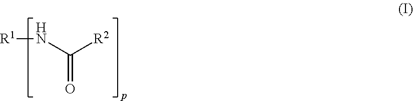

In this formula, R¹ is a p-valent radical of a linear or branched polyurethane prepolymer terminated by isocyanate groups, following the removal of the terminal isocyanate groups, and p has a value of 2 to 8.

Moreover, R² independently at each occurrence is a substituent which is selected from the group consisting of

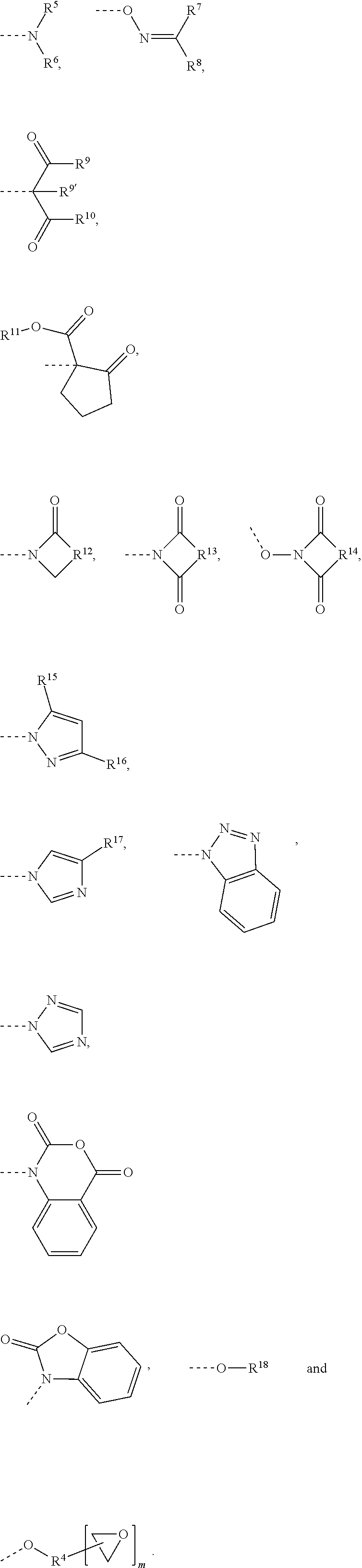

In these formulae, R⁵, R⁶, R⁷ and R⁸ each independently of one another are an alkyl or cycloalkyl or aralkyl or arylalkyl group, or R⁵ together with R⁶, or R⁷ together with R⁸, forms part of a 4- to 7-membered ring which is optionally substituted.

Moreover, R^{9′} and R¹⁰ each independently of one another are an alkyl or aralkyl or arylalkyl group or are an alkyloxy or aryloxy or aralkyloxy group, and R¹¹ is an alkyl group.

R¹², R¹³ and R¹⁴ each independently of one another are an alkylene group having 2 to 5 carbon atoms, which optionally has double bonds or is substituted, or are a phenylene group or are a hydrogenated phenylene group.

R¹⁵, R¹⁶ and R¹⁷ each independently of one another are H or are an alkyl group or are an aryl group or an aralkyl group, and R¹⁸ is an aralkyl group or is a mono- or polycyclic, substituted or unsubstituted aromatic group which optionally has aromatic hydroxyl groups.

Lastly, R⁴ is a radical of an aliphatic, cycloaliphatic, aromatic or araliphatic epoxide containing a primary or secondary hydroxyl group, after the removal of the hydroxyl and epoxide groups, and m has a value of 1, 2 or 3.

R¹⁸ should be considered to comprise, in particular, on the one hand, phenols or polyphenols, more particularly bisphenols, after removal of a hydroxyl group. Preferred examples of such phenols and bisphenols are, in particular, phenol, cresol, resorcinol, pyrocatechol, cardanol (3-pentadecenylphenol (from cashew nut shell oil)), nonylphenol, phenols reacted with styrene or with dicyclopentadiene, bisphenol A, bisphenol F and 2,2′-diallylbisphenol A. R¹⁸ should be considered on the other hand to comprise, in particular, hydroxybenzyl alcohol and benzyl alcohol after removal of a hydroxyl group.

If R⁵, R⁶, R⁷, R⁸, R⁹, R⁹, R¹⁰, R¹¹, R¹⁵, R¹⁶ or R¹⁷ is an alkyl group, this group more particularly is a linear or branched C₁-C₂₀ alkyl group.

If R⁵, R⁶, R⁷, R⁸, R⁹, R⁹, R¹⁰, R¹⁵, R¹⁶, R¹⁷ or R¹⁸ is an aralkyl group, this moiety is more particularly an aromatic group bonded via methylene, more particularly a benzyl group.

If R⁵, R⁶, R⁷, R⁸, R⁹, R⁹ or R¹⁰ is an alkylaryl group, this group is more particularly C₁ to C₂₀ alkyl group bonded via phenylene, such as tolyl or xylyl, for example.

The radicals R² are preferably the substituents of the formulae

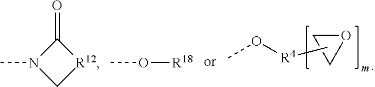

A preferred substituent of the formula

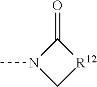

is ε-caprolactam after removal of the NH proton.

Preferred substituents of the formula

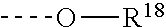

are monophenols or polyphenols, more particularly bisphenols, after removal of a phenolic hydrogen atom. Particularly preferred examples of such radicals R² are radicals which are selected from the group consisting of

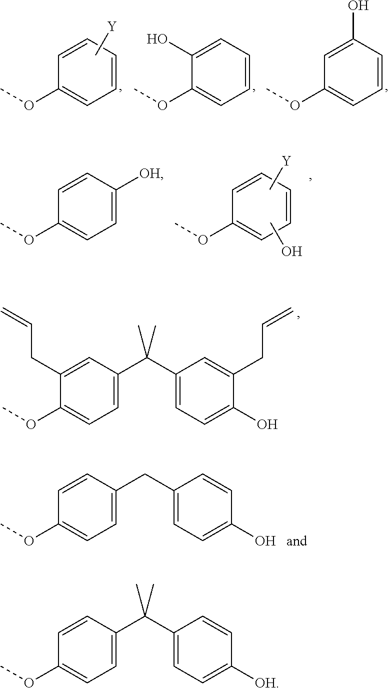

The radical Y in these formulae is a saturated, aromatic or olefinically unsaturated hydrocarbyl radical having 1 to 20 carbon atoms, more particularly having 1 to 15 carbon atoms. Preferred as Y are, in particular, allyl, methyl, nonyl, dodecyl, phenyl, alkyl ether, carboxylic ester or an unsaturated C₁₅ alkyl radical having 1 to 3 double bonds.

Most preferably R² is

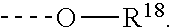

The terminally blocked polyurethane prepolymer of the formula (I) is prepared from the linear or branched polyurethane prepolymer, terminated by isocyanate groups, with one or more isocyanate-reactive compounds R²H. If two or more such isocyanate-reactive compounds are used, the reaction may take place sequentially or with a mixture of these compounds.

The reaction preferably takes place such that the one or more isocyanate-reactive compounds R²H are used stoichiometrically or in a stoichiometric excess, in order to ensure that all of the NCO groups have undergone reaction.

The polyurethane prepolymer having isocyanate end groups on which R¹ is based may be prepared from at least one diisocyanate or triisocyanate and also from a polymer Q_{PM} having terminal amino, thiol or hydroxyl groups and/or from an optionally substituted polyphenol Q_{PP}.

Suitable diisocyanates are aliphatic, cycloaliphatic, aromatic or araliphatic diisocyanates, especially commercial products such as methylenediphenyl diisocyanate (MDI), hexamethylene diisocyanate (HDI), toluene diisocyanate (TDI), tolidine diisocyanate (TODI), isophorone diisocyanate (IPDI), trimethylhexamethylene diisocyanate (TMDI), 2,5- or 2,6-bis(isocyanatomethyl)bicyclo[2.2.1]heptane, naphthalene 1,5-diisocyanate (NDI), dicyclohexylmethyl diisocyanate (H₁₂MDI), p-phenylene diisocyanate (PPDI), m-tetramethylxylylene diisocyanate (TMXDI), etc., and also their dimers. Preferred are HDI, IPDI, MDI or TDI.

Suitable triisocyanates are trimers or biurets of aliphatic, cycloaliphatic, aromatic or araliphatic diisocyanates, more particularly the isocyanurates and biurets of the diisocyanates described in the preceding paragraph. It is of course also possible to use suitable mixtures of di- or triisocyanates.

Particularly suitable as polymers Q_{PM} having terminal amino, thiol or hydroxyl groups are polymers Q_{PM} having two or three terminal amino, thiol or hydroxyl groups.

The polymers Q_{PM} advantageously have an equivalent weight of 300-6000, more particularly of 600-4000, preferably of 700-2200 g/equivalent of NCO-reactive groups.

Preferred polymers Q_{PM} are polyols having average molecular weights of between 600 and 6000 daltons, selected from the group consisting of polyethylene glycols, polypropylene glycols, polyethylene glycol-polypropylene glycol block polymers, polybutylene glycols, hydroxyl-terminated polybutadienes, hydroxyl-terminated butadiene-acrylonitrile copolymers, and mixtures thereof.

Especially preferred as polymers Q_{PM} are α,ω-dihydroxypolyalkylene glycols having C₂-C₆ alkylene groups or having mixed C₂-C₆ alkylene groups, which are terminated with amino, thiol or, preferably, hydroxyl groups. Particularly preferred are polypropylene glycols or polybutylene glycols. Further particularly preferred are hydroxyl-group-terminated polyoxybutylenes.

Especially suitable as polyphenol Q_{PP} are bis-, tris- and tetraphenols. The term refers not only to pure phenols, but instead also, where appropriate, to substituted phenols. The nature of the substitution can be very diverse. Understood more particularly by this is substitution directly on the aromatic ring system to which the phenolic OH group is bonded. Phenols, moreover, are not only monocyclic aromatics, but also polycyclic or fused aromatic or heteroaromatics, having the phenolic OH group directly on the aromatic or heteroaromatic moiety.

In one preferred embodiment, the polyurethane prepolymer is prepared from at least one diisocyanate or triisocyanate and also from one polymer Q_{PM} having terminal amino, thiol or hydroxyl groups. The polyurethane prepolymer is prepared in a manner known to the person skilled in the polyurethane art, more particularly by using the diisocyanate or triisocyanate in a stoichiometric excess in relation to the amino, thiol or hydroxyl groups of the polymer Q_{PM}.

The polyurethane prepolymer having isocyanate end groups is preferably elastic in nature. It preferably exhibits a glass transition temperature Tg of less than 0° C.

The toughness improver D may be a liquid rubber D2. This may be, for example, a carboxyl-terminated or epoxide-terminated polymer.

In a first embodiment, this liquid rubber may be a carboxyl- or epoxide-terminated acrylonitrile/butadiene copolymer or a derivative thereof. Liquid rubbers of this kind are available commercially, for example, under the name Hypro/Hypox® CTBN and CTBNX and ETBN from Emerald Performance Materials. Suitable derivatives are, in particular, elastomer-modified prepolymers containing epoxide groups, of the kind marketed commercially under the product line Polydis®, especially from the product line Polydis® 36 . . . , by the company Struktol® (Schill+Seilacher Group, Germany), or under the product line Albipox (Evonik, Germany).

In a second embodiment, this liquid rubber may be a polyacrylate liquid rubber, which is fully miscible with liquid epoxy resins and which separates only when the epoxy resin matrix is cured, to form microdroplets. Liquid polyacrylate rubbers of this kind are available, for example, under the designation 20208-XPA from Dow.

It is of course also possible to use mixtures of liquid rubbers, more particularly mixtures of carboxyl- or epoxide-terminated acrylonitrile/butadiene copolymers or of derivatives thereof.

The toughness improver D in a third embodiment may be a core-shell polymer D3. Core-shell polymers consist of an elastic core polymer and a rigid shell polymer. Particularly suitable core-shell polymers are composed of a core of elastic acrylate polymer or butadiene polymer, surrounded by a rigid shell of a rigid thermoplastic polymer. This core-shell structure either forms spontaneously by separation of a block copolymer, or is dictated by the polymerization regime as latex or suspension polymerization with subsequent grafting. Preferred core-shell polymers are those known as MBS polymers, which are available commercially under the trade name Clearstrength™ from Arkema, Paraloid™ from Dow or F-351™ from Zeon.

With particular preference the one-component thermosetting epoxy resin adhesive comprises terminally blocked polyurethane polymers D1, most preferably only terminally blocked polyurethane polymers D1.

In one preferred embodiment, the one-component thermosetting epoxy resin adhesive further comprises at least one filler F. Preference here is given to mica, talc, kaolin, wollastonite, feldspar, syenite, chlorite, bentonite, montmorillonite, calcium carbonate (precipitated or ground), dolomite, quartz, silicas (fumed or precipitated), cristobalite, calcium oxide, aluminium hydroxide, magnesium oxide, hollow ceramic beads, hollow glass beads, hollow organic beads, glass beads, colour pigments. Particularly preferred are fillers selected from the group consisting of calcium carbonate, calcium oxide and fumed silicas.

The total fraction of the overall filler F is advantageously 5-40 weight-%, preferably 10-35 weight-%, 15-30 weight-%, most preferably 20-30 weight-%, based on the total weight of the epoxy resin adhesive.

The one-component thermosetting epoxy resin adhesive may comprise further constituents, especially stabilizers, particularly heat and/or light stabilizers, plasticizers, solvents, dyes and pigments, corrosion inhibitors, surfactants, defoamers and adhesion promoters.

The one-component thermosetting epoxy resin adhesive preferably has a viscosity of 500 to 5000 Pas at 25° C. Preferably, the viscosity is from 500 to 2000 Pas, 500 to 1500 Pas, preferably 500 to 1300 Pas at 25° C. The viscosity is determined oscillographically by means of a rheometer with heatable plate (MCR 301, AntonPaar) (gap 1000 μm, measuring plate diameter: 25 mm (plate/plate), deformation 0.01 at 5 Hz, temperature: 25° C.).

A particularly preferred thermosetting one-component epoxy resin adhesive comprises:
at least one epoxy resin A of the formula (II), wherein the substituents R′ and R″ independently of one another are either H or CH₃ and the index s has a value of 0-12, preferably 0-1; and
at least one epoxy novolac EN, where R2=

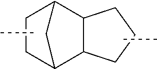

or CH₂, R1=H or methyl and z=0-7, preferably 0-3, 1-2, most preferably 1.2-2;
at least one trifunctional or higher functional glycidyl amine type epoxy resin GA, preferably selected from the list consisting of formula (III), formula (IV) and formula (V), preferably formula (III), wherein the substituents R″′ and R″″ independently of one another are either H or CH₃, preferably H;
1-8 wt %, more particularly 2-6 wt %, based on the total weight of the one-component thermosetting epoxy resin adhesive, of at least one latent hardener B for epoxy resins, more particularly dicyandiamide;
preferably 0.05-2 wt.-%, more particularly 0.1-1 wt.-%, 0.15-0.5 wt.-%, more preferably 0.2-0.3 wt.-%, based on the total weight of the one-component thermosetting epoxy resin adhesive, of at least one accelerator C for epoxy resins;
2-30 wt.-%, preferably from 3-25 wt.-%, 4-20 wt.-%, 5-15 wt.-%, more preferably 5-10 wt.-%, based on the total weight of the one-component thermosetting epoxy resin adhesive, of at least one toughness improver D, preferably a terminally blocked polyurethane polymers D1;
preferably 5-40 weight-%, preferably 10-35 weight-%, 15-30 weight-%, most preferably 20-30 weight-%, based on the total weight of the one-component thermosetting epoxy resin adhesive, of a filler F selected from the group consisting of calcium carbonate, calcium oxide and fumed silicas.

Preferably, the thermosetting one-component epoxy resin adhesive has:
a molar ratio of the epoxy groups of the at least one epoxy novolac EN the at least one trifunctional or higher functional glycidyl amine type epoxy resin GA (EN/GA) of 0.15-12, preferably 0.18-10, 0.18-8, 0.18-5, 0.18-3, 0.2-2, 0.5-1.5, more preferably 0.75-1.25; and/or, preferably and
a molar ratio of the epoxy groups of at least one epoxy resin A:the sum the at least one epoxy novolac EN and the at least one trifunctional or higher functional glycidyl amine type epoxy resin (A/(EN+GA)) of 0.2-2.5, preferably 0.3-2.1, 0.4-1.9, 0.5-1.9, 0.75-1.9, 1-1.9, 1.25-1.9, more preferably 1.5-1.8; and/or, preferably and
a weight ratio of the at least at least one toughness improver D:the sum of the at least one epoxy resin A, the at least one epoxy novolac EN and the at least one trifunctional or higher functional glycidyl amine type epoxy resin (D/(A+EN+GA)) of 1-15, preferably 2-12, 3-11, 3.5-11, 4-11, 4.5-10, 4.5-8, 4.5-6, more preferably 5-5.5.

Preferably, the thermosetting one-component epoxy resin adhesive has a viscosity of 500 to 2000 Pas, 500 to 1500 Pas, preferably 500 to 1300 Pas at 25° C.

It may further be advantageous if the preferred one-component thermosetting epoxy resin adhesive consists to an extent of more than 80 weight %, preferably more than 90 weight %, more particularly more than 95 weight %, especially preferably more than 98 weight %, most preferably more than 99 weight %, based on the total weight of the epoxy resin adhesive, of the aforementioned constituents.

It is advantageous when the cured one-component thermosetting epoxy resin adhesive of the invention after curing for 10 min at 160° C. has the following properties:
LSS, 10 min/160° C. @ 23° C.: ≥18 MPa, preferably ≥20 MPa, ≥22 MPa, ≥24 MPa, ≥25 MPa, most preferably ≥26 MPa.
LSS, 10 min/160° C. @ 80° C.: ≥17.5 MPa, preferably ≥18 MPa, ≥19 MPa, ≥20 MPa, ≥22 MPa, most preferably ≥23 MPa.

It is further advantageous when the cured one-component thermosetting epoxy resin adhesive of the invention after curing for 30 min at 180° C. has the following properties:
T-peel 30 min/180° C. @ 23° C.: ≥1.1 MPa, preferably ≥1.5 MPa, ≥1.6 MPa, ≥1.7 MPa, ≥2.0 MPa, ≥2.5 MPa, most preferably ≥3.0 MPa.

It is also advantageous when the one-component thermosetting epoxy resin adhesive of the invention after curing for 10 min at 160° C. shows a reduction in LSS if measured at 80° C., compared to the value measured at 23° C., of ≤40%, of ≤30%, of ≤20%, preferably ≤15%, ≤12%, most preferably ≤10%.

Preferably the above mentioned properties LSS and T-peel are determined as described in the experimental section.

Adhesives of this kind are needed for the bonding of heat-stable materials. By heat-stable materials are meant materials which are dimensionally stable, at least during the cure time, at a curing temperature of 100-220° C., preferably 120-200° C. They are, more particularly, metals and plastics such as ABS, polyamide, polyphenylene ethers, compounded materials such as SMC, unsaturated polyesters GRP and composite epoxide or acrylate materials. Particularly heat-stable plastics, furthermore, are polysulfones or polyethersulfones. Most preferred are metals.

A preferred application is when at least one material is a metal.

Considered a particularly preferred use is the adhesive bonding of identical or different metals, particularly in body construction within the automotive industry. The preferred metals are, in particular, steel, especially electrolytically galvanized, hot dip galvanized, oiled steel, Bonazinc-coated steel, and subsequently phosphated steel, and also aluminium, particularly in the versions typically encountered in car making.

Such an adhesive is especially contacted first with the materials to be bonded at a temperature of between 10° C. and 80° C., especially between 10° C. and 60° C., and later cured at a temperature of typically 130-220° C., preferably 140-180° C., more preferably 150-170° C.

A further aspect of the present invention relates to a method of bonding heat-stable substrates, comprising the steps of:
i) applying a heat-curing epoxy resin composition as described in detail above to the surface of a heat-stable substrate S1, especially of a metal;
ii) contacting the heat-curing epoxy resin composition applied with the surface of a further heat-stable substrate S2, especially of a metal;
iii) heating the composition to a temperature of 100-220° C., especially of 120-210° C., preferably between 130 and 190° C., 140 and 180° C. more preferably between 150 and 170° C.

The substrate S2 here consists of the same material as or a different material than the substrate S1.

The substrates S1 and/or S2 are especially the aforementioned metals and plastics.

Preferably, in step iii) heating the composition to a temperature of 100-220° C., especially of 120-210° C., preferably between 130 and 190° C., 140 and 180° C. more preferably between 150 and 170° C., the composition is left at the aforementioned temperature for 10 min-6 h, 10 min-2 h, 10 min-60 min, 10 min-30 min, 10 min-20 min, more preferably 10 min-15 min.

Such a method of bonding heat-stable materials results in an adhesive-bonded article. Such an article is preferably a motor vehicle or part of a motor vehicle.

A further aspect of the present invention is therefore an adhesive-bonded article obtained from the aforementioned method. In addition, the compositions of the invention are suitable not just for automobile construction but also for other fields of use. Particular mention should be made of related applications in the transportation sector such as ships, trucks, buses or rail vehicles, or in the construction of consumer goods, for example washing machines.

The materials adhesive-bonded by means of a composition of the invention are used at temperatures between typically 120° C. and −40° C., preferably between 100° C. and −40° C., especially between 80° C. and −40° C.

One particularly preferred use of the thermosetting epoxy resin adhesive of the invention is the use thereof as a thermosetting body construction adhesive in vehicle construction.

A further particularly preferred use of the thermosetting epoxy resin adhesive of the invention is the use thereof for adhesively bonding metal structures.

A further aspect of the present invention therefore relates to the use of at least one epoxy novolac EN and at least one trifunctional or higher functional glycidyl amine type epoxy resin GA as described before for increasing the tensile shear strength at 80° C., preferably after curing for 10 min at 160° C., and/or the angular peel strength at 23° C., preferably after curing for 30 min at 180° C., of a one-component thermosetting epoxy resin adhesive, more particularly of a thermosetting epoxy resin adhesive in vehicle construction and sandwich panel construction, more preferably of a one-component thermosetting epoxy resin adhesive as described before. Preferably, the increase in tensile shear strength and angular peel strength is more than 20%, more than 30%, preferably more than 50%, compared to the same one-component thermosetting epoxy resin adhesive not comprising at least one epoxy novolac EN and/or, preferably and, at least one trifunctional or higher functional glycidyl amine type epoxy resin GA.

The invention is elucidated further in the text below by means of examples which, however, are not intended to restrict the invention in any way.

### EXAMPLES

Preparation of a Toughness Improver (“D-1”)

150 g of poly-THF 2000 (OH number 57 mg/g KOH) and 150 g of PolyBD R45V (OH number 46 mg/g KOH) were dried under reduced pressure at 105° C. for 30 minutes. Once the temperature had been reduced to 90° C., 61.5 g of IPDI and 0.14 g of dibutyltin dilaurate were added. The reaction was conducted under reduced pressure at 90° C. until the NCO content was constant at 3.10% after 2.0 h (calculated NCO content: 3.15%). Subsequently, 96.1 g of cardanol were added as blocking agent. Stirring was continued at 105° C. under reduced pressure until it was no longer possible to detect any free NCO. The product was used as such as toughness improver D-1.

| | |
|---|---|
| A | Liquid epoxy resin of formula (II), diglycidyl ethers of bisphenol |
| | A, EEW 188 g/eq |
| EN | Araldite ® EPN 1183, EEW 145 to 159 g/eq, functionality 3.3, |
| | Huntsman |
| GA | Araldite ® MY 720, tetraglycidyl diaminodiphenyl methane |
| | epoxy resin, EEW 117 to 134 g/eq, Huntsman |
| G | Reactive diluent, p-t-butyl phenyl glycidyl ether, EEW 220 to |
| | 240 g/eq |
| Filler | Filler mixture of calcium carbonate, calcium oxide and fumed |
| | silica |
| DICY | Latent hardener B, Dicyandiamide |
| Urea | Accelerator C for epoxy resins, substituted urea |
| | Poly-THF 2000 (difunctional polybutylene glycol) |
| | (OH equivalent weight = about 1000 g/OH equivalent), BASF |
| | PolyBD R45V (hydroxyl-terminated polybutadiene) |
| | (OH equivalent weight = about 1230 g/OH equivalent), Cray |
| | Valley |
| | Isophorone diisocyanate (=“IPDI”), Evonik |
| | Cardolite NC-700 (cardanol, meta-substituted |
| | alkenylmonophenol), Cardolite |

Raw materials used

Test methods used for the testing of the respective properties in the examples were as follows:

Tensile Shear Strength (LSS)

The determination follows the general lines of ASTM D1002-10. The tensile shear strength was determined using the following set-up (dimensions in mm):
Bond area: 10 mm×20 mm
Adhesive layer thickness: 0.2 mm
Curing: as shown in table 1 (e.g. 10 min/160° C.)
Test temperature: 23° C. (@ RT) or 80° C. (@80° C.) as shown in table 1
Test velocity: 10 mm/min

(T-Peel) (DIN 53281)

Test sheets measuring 130×25 mm made of DC-04+ZE steel (thickness 0.8 mm) were prepared. The cleaned and oiled back with Anticorit PL 3802-39S surfaces of 100×25 mm were bonded with the adhesive containing glass spheres as spacers in a layer thickness of 0.3 mm and cured for 30 min at 180° C. oven temperature (30 min/180° C.). The angular peel strength was determined at 23° C. on a traction machine at a pulling speed of 100 mm/min in a 3-fold determination.

TABLE 1
components shown in weight-% (wt.-%)

| | EEW | Ref. | Ref. | Ref. | Ex. | Ex. | Ex. | Ex. | Ex. | Ex. | Ex. | Ref. |
|---|---|---|---|---|---|---|---|---|---|---|---|---|
| | (g/eq) | 1 | 2 | 3 | 1 | 2 | 3 | 4 | 5 | 6 | 7 | 4 |
| D-1 | | 15 | 15 | 15 | 15 | 15 | 15 | 15 | 15 | 9 | 5 | 15 |
| A | 188 | 41 | 18.5 | 18.5 | 18.5 | 18.5 | 18.5 | 18.5 | 32.3 | 18.5 | 18.5 | 18.5 |
| G | 232.5 | | | | | | | | | | | 7.5 |
| EN | 151.5 | | | 28.5 | 5 | 14.25 | 21 | 26 | 11 | 21 | 21 | 21 |
| GA | 125.5 | | 28.5 | | 23.5 | 14.25 | 7.5 | 2.5 | 3.7 | 7.5 | 7.5 | |
| Filler | | 39.8 | 33.8 | 33.8 | 33.8 | 33.8 | 33.8 | 33.8 | 33.8 | 39.8 | 43.8 | 33.8 |
| DICY | | 4 | 4 | 4 | 4 | 4 | 4 | 4 | 4 | 4 | 4 | 4 |
| Urea | | 0.2 | 0.2 | 0.2 | 0.2 | 0.2 | 0.2 | 0.2 | 0.2 | 0.2 | 0.2 | 0.2 |
| Sum (wt.-%) | | 100 | 100 | 100 | 100 | 100 | 100 | 100 | 100 | 100 | 100 | 100 |
| LSS, 10 min/160° C., @ RT (MPa) | | 25 | 19.1 | 23 | 19.8 | 24.3 | 24.6 | 26 | 27.7 | 26.5 | 25.4 | 24.5 |
| LSS, 10 min/160° C., @ 80° | | 12.5 | 16.5 | 17.3 | 19 | 22 | 17.7 | 18.6 | 18.6 | 22.4 | 23.6 | 10.7 |
| C. (MPa) | | | | | | | | | | | | |
| LSS, 20 min/175° C., @ RT (MPa) | | 30.1 | 17 | 27.2 | 21.6 | 24.9 | 25.7 | 26.2 | 29.9 | 28.2 | 26.8 | 27.4 |
| LSS, 20 min/175° C., @ 80° | | 21.2 | 16 | 21 | 17.6 | 20.4 | 21.8 | 21 | 22 | 23.6 | 24.1 | 13.3 |
| C. (MPa) | | | | | | | | | | | | |
| T-peel 30 min/180° C., @ RT (MPa) | | 8.3 | 1.2 | 1.4 | 1.1 | 1.7 | 1.7 | 2.3 | 8.3 | 3.2 | 2.9 | 5.5 |
| A/(EN + GA) (wt.-%) | | — | 0.65 | 0.65 | 0.65 | 0.65 | 0.65 | 0.65 | 2.20 | 0.65 | 0.65 | 0.65 |
| EN/GA (wt.-%) | | — | 0 | — | 0.21 | 1.00 | 2.80 | 10.40 | 2.97 | 2.80 | 2.80 | 2.8 |
| A/(EN + GA) (molar ratio | | — | 0.43 | 0.52 | 0.45 | 0.47 | 0.50 | 0.51 | 1.68 | 0.50 | 0.50 | 0.58 |
| epoxy groups) | | | | | | | | | | | | |
| EN/GA (molar ratio epoxy groups) | | — | 0 | — | 0.18 | 0.83 | 2.32 | 8.62 | 2.46 | 2.32 | 2.32 | 4.30 |
| (A + EN + GA)/D-1 (wt.-%) | | 2.73 | 3.13 | 3.13 | 3.13 | 3.13 | 3.13 | 3.13 | 3.13 | 5.22 | 9.40 | 3.13 |

1. One-component thermosetting epoxy resin adhesive, comprising
a) at least one epoxy resin A of the formula (II) 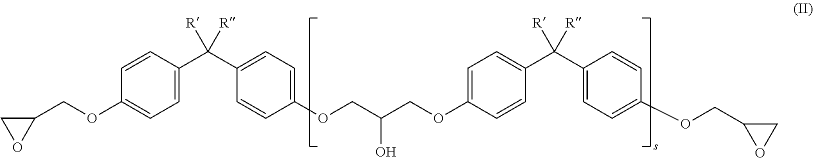
wherein the substituents R′ and R″ independently of one another are either H or CH₃ and the index s has a value of 0-12; and
b) at least one epoxy novolac EN of the formula 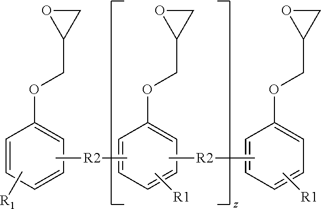
where R2= 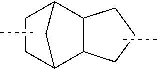
or CH₂, R1=H or methyl and z=0-7; and
c) at least one trifunctional or higher functional glycidyl amine type epoxy resin GA
d) at least one latent hardener B for epoxy resins; and
e) optionally at least one accelerator C for epoxy resins; and
f) at least at least one toughness improver D.

2. One-component thermosetting epoxy resin adhesive according to claim 1, wherein the molar ratio of the epoxy groups of the at least one epoxy novolac EN: the at least one trifunctional or higher functional glycidyl amine type epoxy resin GA (EN/GA) is 0.15-12.

3. One-component thermosetting epoxy resin adhesive according to claim 1, wherein the molar ratio of the epoxy groups of the at least one epoxy novolac EN:the at least one trifunctional or higher functional glycidyl amine type epoxy resin GA (EN/GA) is 0.15-12.

4. One-component thermosetting epoxy resin adhesive according to claim 1, wherein the molar ratio of the epoxy groups of the at least one epoxy resin A: the sum the at least one epoxy novolac EN and the at least one trifunctional or higher functional glycidyl amine type epoxy resin GA (A/(EN+GA)) is 0.2-2.5.

5. One-component thermosetting epoxy resin adhesive according to claim 1, wherein the weight ratio of the at least at least one toughness improver D:the sum of the at least one epoxy resin A, the at least one epoxy novolac EN and the at least one trifunctional or higher functional glycidyl amine type epoxy resin GA (D/(A+EN+GA)) is 1-15.

6. One-component thermosetting epoxy resin adhesive according to claim 1, wherein the trifunctional or higher functional glycidyl amine type epoxy resin GA is selected from the list consisting of 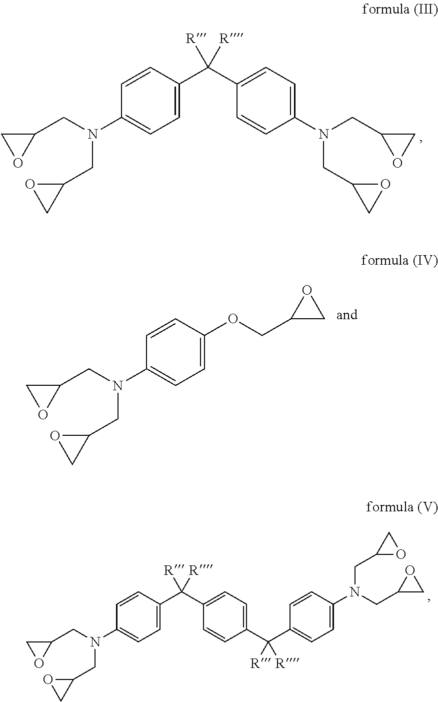
wherein the substituents R″′ and R″″ independently of one another are either H or CH₃.

7. One-component thermosetting epoxy resin adhesive according to claim 1, wherein the latent hardener B is selected from dicyandiamide, guanamines, guanidines, aminoguanidines and derivatives thereof, substituted ureas, imidazoles and amine complexes.

8. One-component thermosetting epoxy resin adhesive according to claim 1, wherein the accelerator C for epoxy resins is selected from the list consisting of substituted ureas, imidazoles, imidazolines and blocked amines.

9. One-component thermosetting epoxy resin adhesive according to claim 1, wherein the fraction of toughness improver D is from 2-30 wt.-% based on the total weight of the one-component thermosetting epoxy resin adhesive.

10. One-component thermosetting epoxy resin adhesive according to claim 1, wherein the toughness improver D is selected from the group consisting of terminally blocked polyurethane polymers D1, liquid rubbers D2 and core-shell polymers D3.

11. One-component thermosetting epoxy resin adhesive according to claim 1, wherein the adhesive after curing for 10 min at 160° C. has a tensile shear strength at 80° C. of ≥17.5 MPa.

12. Method for adhesively bonding heat-stable substrates, comprising the steps of
i) applying a thermosetting epoxy resin adhesive according to claim 1 to the surface of a heat-stable substrate S1;
ii) contacting the applied thermosetting epoxy resin adhesive with the surface of a further heat-stable substrate S2;
iii) heating the thermosetting epoxy resin adhesive to a temperature of 100-220° C.;
wherein the substrate S2 consists of the same material as or a different material to the substrate S1.

13. Method according to claim 12, wherein step iii) heating the composition to a temperature of 100-220° C., the composition is left at the aforementioned temperature for 10 min-6 h.

14. Method comprising adhesively bonding or strengthening metal structures or strengthening filling of cavities in vehicle construction or sandwich panel construction with a thermosetting epoxy resin adhesive according to claim 1.

15. A method comprising applying at least one epoxy novolac EN and at least one trifunctional or higher functional glycidyl amine type epoxy resin GA as described as epoxy novolac EN and trifunctional or higher functional glycidyl amine type epoxy resin GA in claim 1, for increasing the tensile shear strength at 80° C., and/or the angular peel strength at 23° C., of a one-component thermosetting epoxy resin adhesive.
